(19) United States
(12) Patent Application Publication
(10) Pub. No.: US 2014/0319299 A1
(43) Pub. Date: Oct. 30, 2014

(54) FASTENING DEVICE FOR A COMPONENT ON A MOTOR VEHICLE

(71) Applicant: Dr. Ing. h.c. F. Porsche Aktiengesellschaft, Stuttgart (DE)

(72) Inventors: Michael Baum, Tiefenbronn-Lehningen (DE); Achim Deuschle, Wolfschlugen (DE)

(73) Assignee: Dr. Ing. h.c. F. Porsche Aktiengesellschaft, Stuttgart (DE)

(21) Appl. No.: 14/257,374

(22) Filed: Apr. 21, 2014

(30) Foreign Application Priority Data
Apr. 24, 2013 (DE) 102013104116.7

(51) Int. Cl. H01Q 1/12; H01Q 1/32; B60C 23/04

(52) U.S. Cl. CPC H01Q 1/12; B60C 23/0452; H01Q 1/3208; B60R 2011/005
USPC 248/251

(57) ABSTRACT

A fastening apparatus for a component on a motor vehicle, in particular for a receiving aerial for a tire control device, including a receptacle for the receiving aerial and a holder for fastening the receptacle to the motor vehicle in the vicinity of the wheel, the holder which is connected to the receptacle having an attachment part, via which the holder can be fastened to a vehicle-side screw connection.

### CROSS-REFERENCE TO RELATED APPLICATIONS

This application claims priority to German Patent Application No. DE 10 2013 104 116.7, filed Apr. 24, 2013, which is incorporated by reference herein in its entirety.

### FIELD OF THE INVENTION

The invention relates to a fastening apparatus for a component on a motor vehicle, in particular for a receiving aerial for a tire control device, consisting of a receptacle for the receiving aerial and a holder for fastening the receptacle to the motor vehicle in the vicinity of the wheel.

### BACKGROUND OF THE INVENTION

Modern motor vehicles are nowadays equipped with a multiplicity of monitoring devices. These increasingly also include a tire control device, by way of which primarily the tire pressure, but also, for example, the tire temperature, can be monitored continuously during operation of a motor vehicle, in particular for safety reasons. Tire control devices of this type consist of a transmitting electronics system which is arranged in the vehicle tire, usually a sensor, which wirelessly transmits the values which are recorded by it continuously or at time intervals to a transponder unit or receiving aerial. Said receiving aerial is to be attached on the vehicle as far as possible in the vicinity of the measuring location, that is to say in the vicinity of the sensor which is situated in the wheel, and it is to be ensured that the signals which are emitted by the sensors can be received by the receiving aerial in a manner which is disruption-free, in particular reflection-free and such that they can be assigned to the measuring location, and can be transported from there via the on-board electrical system to a corresponding evaluation and display device.

A number of fastening alternatives for receiving aerials of this type are known from the prior art. For example, DE 100 27 882 B4, which is incorporated by reference herein, describes a specially configured holder which can be screwed fixedly to any desired position in the wheel arch and to which the receiving aerial can be clipped without the use of tools.

DE 20 2006 016 380 U1, which is incorporated by reference herein, discloses a holder which is to be fixed to the vehicle in a simple way by way of latching elements; the aerial or aerial lines is/are then likewise to be fixed thereon via latching elements.

DE 10 2007 009 155 A1, which is incorporated by reference herein, has disclosed a tire pressure control device, in which the receiving aerial is to be received by a holding device which is to be an integral constituent part of the wiping water container of the vehicle or the wiping water container base. A simple central arrangement of this type of the receiving aerial does not meet the relatively modern requirements for a tire control device in every case; modern devices require a clear assignment to an axle or to a wheel of the motor vehicle, in order for it to be possible to determine unambiguously from which tire a received signal is coming.

DE 10 2008 014 502 A1, which is incorporated by reference herein, has disclosed an aerial element which is fastened on a separate mounting bracket; the mounting bracket is to be clipped fixedly via holding brackets which are formed integrally on it and have semicircular receiving openings to water pipes, for example of the vehicle cooling system, on the underbody of the motor vehicle. This fastening possibility is suitable only where the course and arrangement of water pipes of this type on the underbody of the vehicle meet the preconditions which are required for disruption-free and unambiguous reception of the signals from the tire sensor.

### SUMMARY OF THE INVENTION

The invention relates to providing fastening which is as simple as possible for, for example, a receiving aerial for a tire control device in a motor vehicle, which fastening should ensure best possible positioning in relation to the transmitting electronics which are integrated in the wheels of the vehicle, and, above all, also permanent retention of the position in the use conditions of motor vehicles, which use conditions are rough under some circumstances.

According to aspects of the invention, the aforementioned holder which is connected to a receptacle for the receiving aerial has an attachment part, via which it can be fastened to a vehicle-side screw connection.

The screw connection can preferably be the screw connection of one of the bearings, by way of which an anti-roll bar is fastened to the front and/or the rear axle of a vehicle. With regard to the function of the anti-roll bar, said bearing points as a rule lie far to the outside in each case in the vicinity of the wheel, as far as possible, as viewed from the center axis of the vehicle. In a simple way, the attachment part which supports the holder of the receiving aerial can be screwed together with the screw connection of an anti-roll bar during the installation of the latter. Ideally, the anti-roll bar bearing which lies at the bottom opposite the roadway is used for this purpose, since said bearing is arranged such that it is relatively freely accessible with respect to components which are arranged around it, and therefore exhibits ideal positioning not only for mounting purposes, but also for the disruption-free reception of the signals from the wheel sensor.

The use of one of the screw connections of an anti-roll bar bearing for fastening the receiving aerial for the tire control device saves material costs, weight and assembly time. The positioning of the aerials close to the wheel and in a relatively exposed manner is very suitable with regard to the most modern versions of tire control devices, since said positioning makes it possible without problems to differentiate in a robust way between the signals to be evaluated, according to front or rear axle or according to an individual wheel. According to one preferred embodiment of the subject matter of the invention, the holder for the receiving aerial can be capable of being clipped fixedly or screwed to the attachment part which is fastened to the screw connection of the anti-roll bar bearing.

A particularly robust refinement of the subject matter of the invention results if the metallic attachment part, by way of which the fastening of the unit to the anti-roll bar bearing takes place, is injection-molded into the holder of the receiving aerial, which holder is composed of signal-transmissive plastic, and the holder can be screwed, together with the attachment part, as one structural unit to one of the anti-roll bar bearings.

The receiving aerial can in turn be capable of being attached to the holder or inserted into the holder in a simple way in a non-positive and/or positively locking manner. At least one holding bracket can be formed integrally on the holder and/or on the attachment part in order to fasten the aerial signal line, by way of which the receiving aerial is coupled to the on-board electrical system of the motor vehicle. The aerial signal line can be clipped fixedly, for example with a grommet which surrounds it, into said holding bracket having a receptacle of substantially fork-shaped configuration.

The holder for the receiving aerial, which holder is composed of plastic, can be configured in a simple way to be so stable that it protects the receiving aerial against damage, for example by way of stone impact. This protective action can be increased further in a simple way in the subject matter of the invention by way of corresponding mounting (particularly sensitive parts, for example signal line connector, arranged so as to point away from the driving direction).

The features of the invention which are stated in the above text and will be explained in detail in the following text using the exemplary embodiments permit a multiplicity of different possible embodiments, as can be seen readily by a person skilled in the art, without departing from the inventive concept as a result. This applies, in particular, to the type of simultaneous fastening of anti-roll bar and fastening apparatus for the receiving aerial of a tire control device to the anti-roll bar bearing, and also to the connection between the holder for the receiving aerial and the component (attachment part), by way of which the holder is fastened to the anti-roll bar bearing. It goes without saying that it also applies to receiving and fastening of the receiving aerial on or in the holder.

### BRIEF DESCRIPTION OF THE DRAWING

Preferred exemplary embodiments of the subject matter of the invention are shown in the drawing. The features of the invention are to be described in further detail in the following text using these examples.

In the drawing:

FIG. 1 shows a first embodiment of a fastening apparatus according to aspects of the invention,

FIG. 2 shows a modified embodiment according to aspects of the invention, and

FIG. 3 shows components of the fastening apparatus in an exploded illustration.

### DETAILED DESCRIPTION OF THE INVENTION

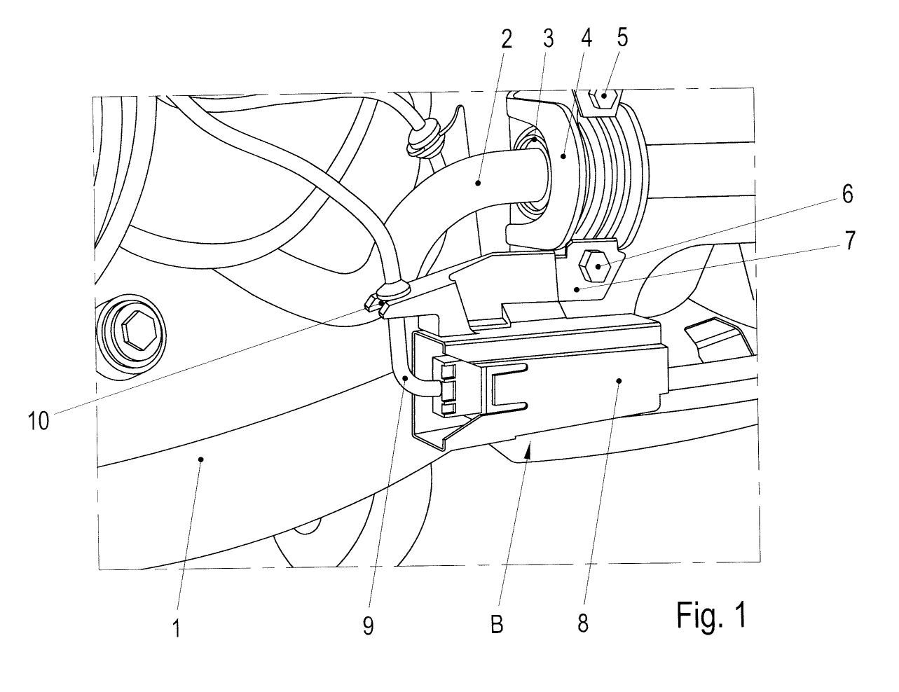

FIG. 1 shows details of the region of the wheel suspension system of a vehicle, in particular of a motor vehicle. The wheel support which is denoted by 1 and that end of an anti-roll bar 2 which is close to the wheel mounting can be seen, which anti-roll bar 2 is fastened in a rotationally movable manner in a rubber bearing 3 of an anti-roll bar bearing 4 which is fastened to the body of the vehicle. The fastening of the anti-roll bar bearing 4 to the body of the motor vehicle takes place via anti-roll bar bearing screw connections 5 and 6.

An attachment part 7 is fastened to the lower (as viewed in the vertical direction of the vehicle) screw connection 6 of the anti-roll bar bearing 4, which attachment part 7 is also screwed fixedly there during the mounting of the anti-roll bar 2 and the anti-roll bar bearing 4. A holder 8 which serves as receptacle for a receiving aerial of a tire control device can be connected to said attachment part 7, for example can be pushed onto it, can be clipped to it or can be screwed to it. The holder 8 can preferably be composed of plastic which is impact-resistant but is transmissive with respect to high-frequency signals. This ensures firstly that the holder 8 protects the receiving aerial appropriately against damage, for example against stone impact. Secondly, robust reception of the signals which are transmitted by the sensor system (not shown) which is arranged in the tire is ensured by way of the relatively freely accessible arrangement of the holder 8 in the immediate vicinity of the wheel.

The receiving aerial is connected via a signal line 9 to the on-board electrical system and to a corresponding signal evaluation/display device of the motor vehicle.

The receiving aerial can be fastened to or in the holder 8 in a non-positive manner. The non-positive connection is ideally supplemented by a positively locking receptacle (in the manner of a cavity) in the holder 8 in order to fasten the receiving aerial reliably.

A fork-shaped receptacle 10 can be provided on the holder 8 itself or optionally also on the attachment part 7 for reliably fastening the aerial signal line 9, in which receptacle 10 the signal line 9 is clamped in a positively locking and non-positive manner by means of a grommet 11 which surrounds it.

FIG. 1 shows one exemplary embodiment, in which the attachment part 7 and holder 8 consist of separate components; the assembly can possibly be simplified as a result. In an embodiment of this type, the component 7 (=attachment part) for robust and secure fastening is as a rule selected to be from metal, whereas the component 8 (=holder) is produced from plastic with regard to its shape and its function. The connection of the two components can take place in different ways as described above.

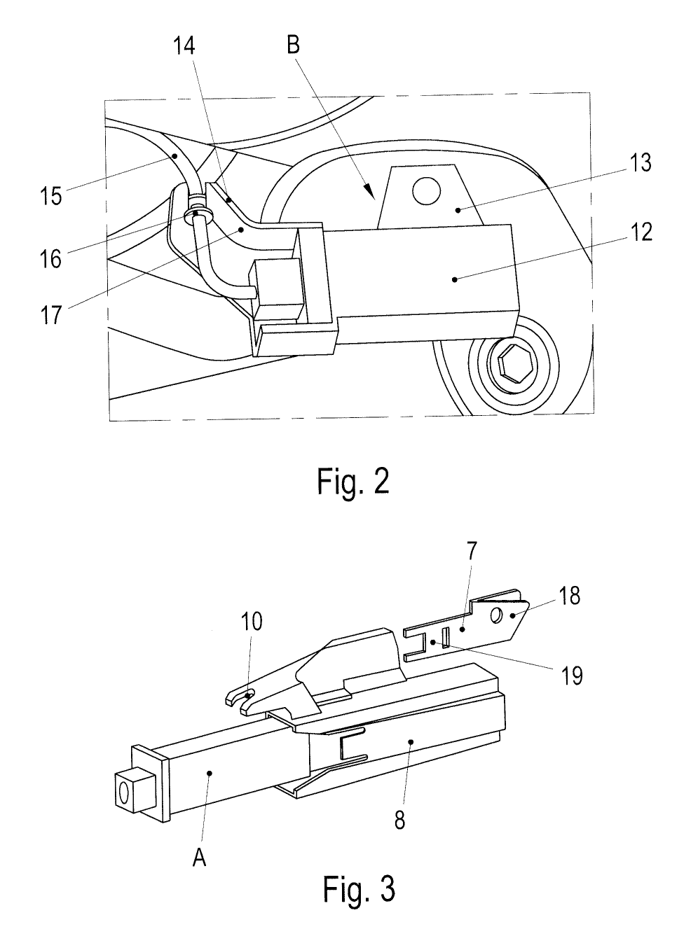

However, it is also conceivable to provide a structural unit which is in one piece for mounting instead of a two-piece embodiment of the fastening apparatus B. Here, the metallic attachment part 13 can be injection-molded into the plastic holder 12 during the production of the latter. A refinement of this type is shown in FIG. 2. Here, the attachment part 13 which is inserted into an injection molding die during the production operation for injection molding encapsulation with plastic is connected fixedly to the holder 12; the structural unit 12, 13 is then screwed on the anti-roll bar bearing in accordance with FIG. 1 in order to fasten the fastening apparatus B.

The receptacle 14 for fastening the signal line 15 via a grommet 16 is formed in one piece on the holder 12 via an arm 17.

FIG. 3 shows an exploded illustration of the essential components of a fastening apparatus B according to aspects of the invention. The metallic attachment part 7 has a fastening socket 18 (for the screw connection to the anti-roll bar bearing 6). The web 19 is configured in such a way that it is either suitable for the non-positive and/or positively locking connection to the component 8 (exemplary embodiment in FIG. 1) or can also be encapsulated in the production die during the production of the holder 8, 12 from plastic in the alternative refinement.

The fork-shaped receptacle 10 for fixing the signal line 9 is formed in one piece on the holder 8. The receiving aerial A is pushed into a receptacle in the holder 8, which receptacle is in the manner of a cavity in the exemplary embodiment, and is preferably fastened securely there in a non-positive and positively locking manner.

### LIST OF DESIGNATIONS

A Receiving aerial
B Fastening apparatus
1 Wheel support
2 Anti-roll bar (end)
3 Rubber bearing
4 Anti-roll bar bearing
5, 6 Screw connection for 4
7 Attachment part
8 Holder
9 Signal line
10 Fork-shaped receptacle
11 Grommet for 9
12 Holder
13 Attachment part
14 Receptacle
15 Signal line
16 Grommet
17 Arm
18 Fastening socket
19 Web

What is claimed:

1. A fastening apparatus for a receiving aerial for a tire control device on a motor vehicle, said apparatus comprising a receptacle for the receiving aerial and a holder for fastening the receptacle to the motor vehicle in a vicinity of a wheel of the motor vehicle, wherein the holder which is connected to the receptacle has an attachment part, via which said holder is configured to be fastened to a vehicle-side screw connection.

2. The fastening apparatus as claimed in claim 1, wherein the vehicle-side screw connection is an anti-roll bar bearing.

3. The fastening apparatus as claimed in claim 2, wherein the holder is configured to be clipped fixedly and/or screwed to the attachment part which is configured to be fixed on the screw connection of the anti-roll bar bearing.

4. The fastening apparatus as claimed in claim 1, wherein the attachment part is metallic and is injection-molded into the holder for the receiving aerial, which holder is composed of signal-transmissive plastic.

5. The fastening apparatus as claimed in claim 4, wherein the receiving aerial is configured to be inserted into the holder in a non-positive and/or positively locking manner.

6. The fastening apparatus as claimed in claim 1, wherein the holder and/or the attachment part has at least one integrally formed holding bracket for fixing an aerial signal line.

7. The fastening apparatus as claimed in claim 1, wherein the holder for the receiving aerial is configured in such a way that it largely covers the receiving aerial as protection against damage.
